(19) United States
(12) Patent Application Publication
(10) Pub. No.: US 2019/0334323 A1
(43) Pub. Date: Oct. 31, 2019

(54) SPARK PLUG PRODUCTION METHOD

(71) Applicant: NGK SPARK PLUG CO., LTD., nagoya-shi, Aichi (JP)

(72) Inventor: Takuya SHIMAMURA, Iwakura-shi, Aichi (JP)

(73) Assignee: NGK SPARK PLUG CO., LTD., Nagoya-shi, Aichi (JP)

(21) Appl. No.: 16/310,863

(22) PCT Filed: Apr. 25, 2017
(86) PCT No.: PCT/JP2017/016253

§ 371 Date: Dec. 18, 2018

(30) Foreign Application Priority Data
Jun. 22, 2016 (JP) 2016-123876
Mar. 24, 2017 (JP) 2017-059596

(51) Int. Cl. H01T 21/02; H01T 13/32

(52) U.S. Cl. CPC H01T 21/02; H01T 13/32

(57) ABSTRACT

A method for manufacturing a spark plug. A first surface having an area larger than or equal to an area making contact with the tip is produced on the electrode base material by performing at least one of polishing and grinding thereon, and a second surface having an area larger than or equal to an area making contact with a first electrode is produced on the electrode base material by performing polishing or the like thereon. Resistance welding is performed by applying current between the first electrode and a second electrode, after the first surface of the electrode base material and the tip have been brought into contact with each other, the first electrode has been brought into contact with the second surface of the electrode base material, and the second electrode has been brought into contact with the tip.

### FIELD OF THE INVENTION

The present invention relates to a method for manufacturing a spark plug and particularly relates to a method for manufacturing a spark plug such that variations in welding of an electrode base material and a tip can be suppressed.

### BACKGROUND OF THE INVENTION

A spark plug is known which includes: a ground electrode in which a tip containing a noble metal is joined to an electrode base material; and a center electrode opposing the ground electrode with a spark gap therebetween. Resistance welding is one of the methods for joining the electrode base material and the tip together. Resistance welding is performed by applying current between the first electrode and the second electrode, in a state where the electrode base material and the tip stacked with each other are in contact with a first electrode and a second electrode, respectively. Japanese Patent Application Laid-Open (kokai) No. 2004-186152 discloses a technique in which the surface of the electrode base material is ground and then resistance welding is performed in a state where the tip is stacked on the ground surface.

However, the above-described conventional technique has the following problem. In resistance welding, the electrode base material and the tip are melted and bonded to each other by Joule heat generated by contact resistance between the electrode base material and the tip. Thus, when variations occur in contact resistance between the electrode base material and the first electrode and contact resistance between the tip and the second electrode, variations occur in welding of the tip and the electrode base material.

The present invention has been made in order to address the aforementioned problem. An advantage of the present invention is a method for manufacturing a spark plug such that variations in welding of an electrode base material and a tip can be suppressed.

### SUMMARY OF THE INVENTION

In accordance with a first aspect of the present invention, there is provided a method for manufacturing a spark plug, wherein a tip containing a noble metal is joined to an electrode base material by means of resistance welding in which current is applied between a first electrode and a second electrode, so that a ground electrode is obtained. In a first step, a first surface having an area larger than or equal to an area making contact with the tip is produced on the electrode base material by performing at least one of polishing and grinding thereon. In a second step, a second surface having an area larger than or equal to an area making contact with the first electrode is produced on the electrode base material by performing at least one of polishing and grinding thereon.

In a welding step, resistance welding is performed by applying current between the first electrode and the second electrode, after the first surface of the electrode base material and the tip have been brought into contact with each other, the first electrode has been brought into contact with the second surface of the electrode base material, and the second electrode has been brought into contact with the tip. Since variations in contact resistance between the electrode base material and the first electrode and variations in contact resistance between the tip and the second electrode can be suppressed, an effect of suppressing variations in welding of the electrode base material and the tip can be obtained.

An arithmetic average roughness of the first surface is not less than an arithmetic average roughness of the second surface. Since the Joule heat that melts the tip and the electrode base material during welding depends on the contact resistance between the first surface of the electrode base material and the tip, in a case where the arithmetic average roughness of the first surface is set to be not less than the arithmetic average roughness of the second surface, the contact resistance between the first surface of the electrode base material and the tip can be ensured. Since the Joule heat generated between the tip and the electrode base material can be ensured, an effect of ensuring joining strength between the electrode base material and the tip can be obtained.

In accordance with a second aspect of the present invention there is provided a method for manufacturing a spark plug as described above, wherein the arithmetic average roughness of each of the first surface and the second surface of the electrode base material is 2 to 4 μm, and the arithmetic average roughness of each of a third surface and a fourth surface of the tip is 0.4 to 0.8 μm. As a result, an effect of suppressing variations in welding of the electrode base material and the tip and of further improving the joining strength between the electrode base material and the tip can be obtained. In addition, the method for manufacturing the spark plug according to a third aspect of the present invention includes an assembling step of assembling a tubular insulator and a tubular metal shell to which the ground electrode is joined, wherein after the assembling step, an electrode base material adjusting step is performed. As a result, an effect of further improving the joining strength between the electrode base material and the tip can be obtained. In addition, the method for manufacturing the spark plug according to a fourth aspect of the present invention includes a third step of producing the third surface on the tip by performing at least one of polishing and grinding thereon, and a fourth step of producing the fourth surface on the tip by performing at least one of polishing and grinding thereon. As a result, the arithmetic average roughness of each of the third surface and the fourth surface of the tip can be easily adjusted.

### BRIEF DESCRIPTION OF THE DRAWINGS

FIG. 1 is a cross-sectional view of a spark plug according to an embodiment of the present invention.

FIG. 2 is a schematic view of a resistance welding machine used in a welding step.

FIG. 3 is a perspective view of a tip and an electrode base material.

FIG. 4 is table showing measurement results of a standard deviation of effective values.

FIG. 5 is a histogram of the number of acceptable samples in a thermal cyclic test.

### DETAILED DESCRIPTION OF THE INVENTION

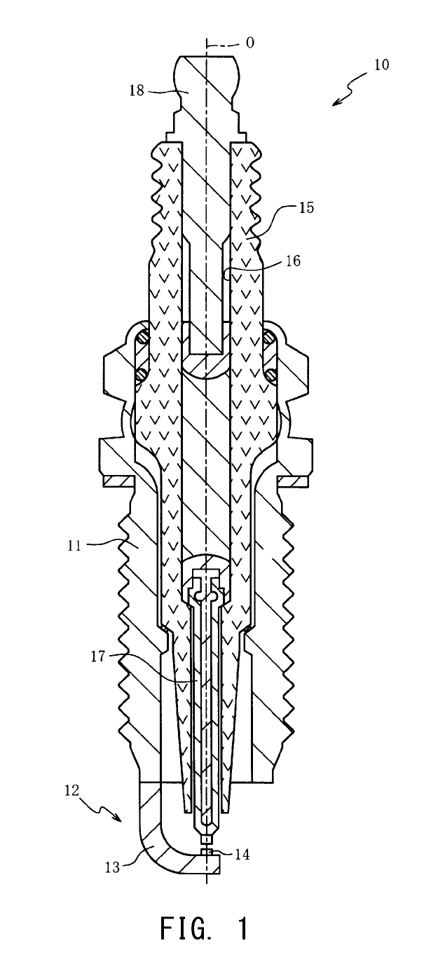

Hereinafter, preferred embodiments of the present invention will be described with reference to the accompanying drawings. FIG. 1 is a cross-sectional view of a spark plug 10, according to an embodiment of the present invention, taken along a plane including a central axis O thereof. As shown in FIG. 1, the spark plug 10 includes a metal shell 11, a ground electrode 12, an insulator 15, a center electrode 17, and a metal terminal 18.

The metal shell 11 is a substantially cylindrical member that is fixed in a thread hole of an internal combustion engine (not shown). The ground electrode 12 includes: an electrode base material 13 that is made of metal (e.g., a nickel-based alloy) and that is joined to a front end of the metal shell 11; and a tip 14 that is joined to the front end of the electrode base material 13. The electrode base material 13 is a rod-shaped member that is bent toward the central axis O so as to intersect the central axis O. The tip 14 is a plate-shaped member formed of a noble metal such as platinum, iridium, ruthenium, or rhodium, or an alloy containing such a noble metal as a principal component, and is joined to the electrode base material 13 by means of resistance welding.

The insulator 15 is a substantially cylindrical member formed of alumina or the like that has excellent mechanical property and insulation property at a high temperature, has an axial hole 16 that penetrates therethrough along the central axis O, and has an outer circumference on which the metal shell 11 is fixed. The center electrode 17 is a rod-shaped electrode that is inserted into the axial hole 16 and held by the insulator 15, and opposes the tip 14 of the ground electrode 12 with a spark gap therebetween. The metal terminal 18 is a rod-shaped member to which a high-voltage cable (not shown) is connected, and a front side of the metal terminal 18 is disposed in the insulator 15.

The spark plug 10 is manufactured by, for example, a method described below. Firstly, the center electrode 17 is inserted into the axial hole 16 of the insulator 15. The center electrode 17 is disposed such that the front end thereof is exposed to the outside from the front end of the axial hole 16. After the metal terminal 18 is inserted into the axial hole 16, so that electrical connection is ensured between the metal terminal 18 and the center electrode 17, the metal shell 11 to which the ground electrode 12 has been joined in advance is assembled to the outer circumference of the insulator 15. After the tip 14 has been joined to the electrode base material 13 of the ground electrode 12 by means of resistance welding, the electrode base material 13 is bent such that the tip 14 opposes the center electrode 17 in the axial direction, so that the spark plug 10 is obtained.

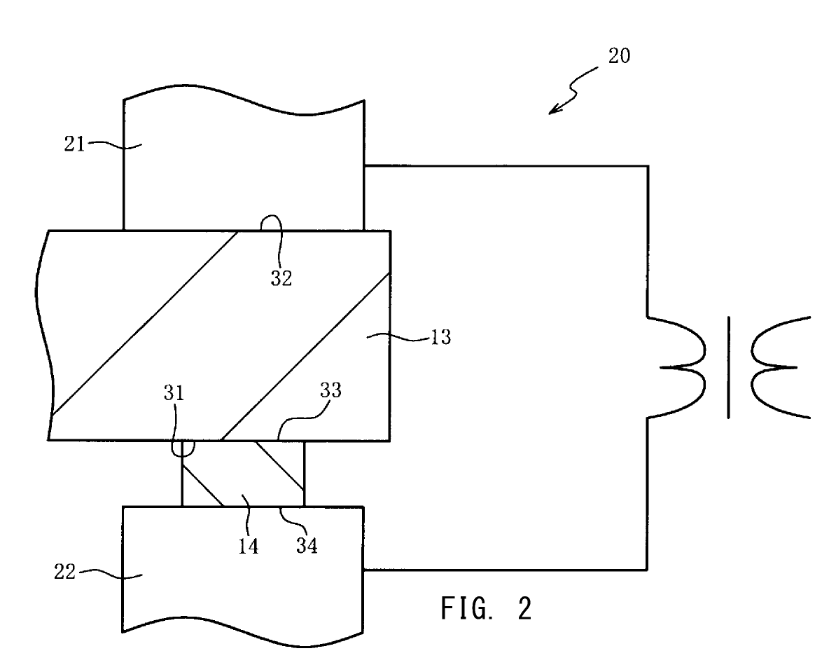

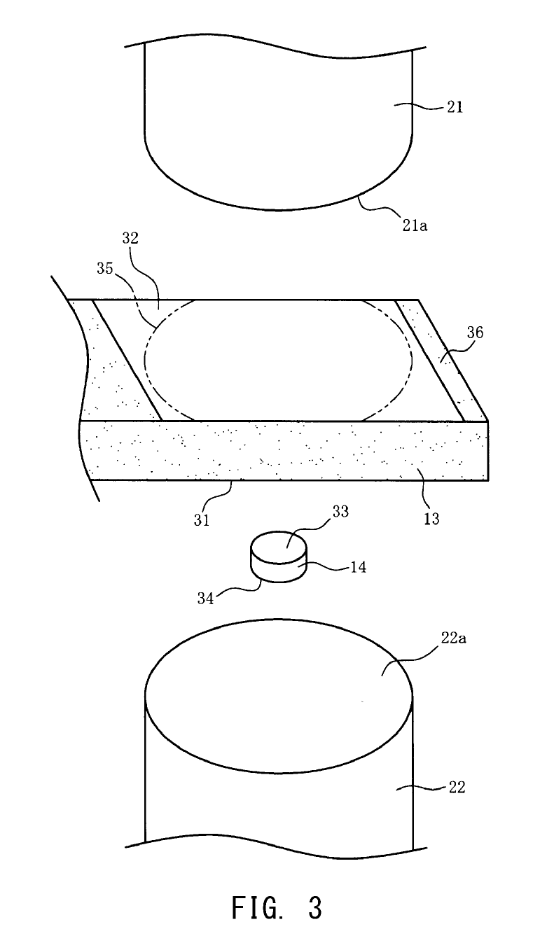

With reference to FIG. 2 and FIG. 3, a method for welding the electrode base material 13 and the tip 14 will be described. FIG. 2 is a schematic view of a resistance welding machine 20 used in a welding step. In FIG. 2, a portion of the electrode base material 13 in a longitudinal direction is not shown.

As shown in FIG. 2, the resistance welding machine 20 includes a first electrode 21 and a second electrode 22 to both of which a transformer is connected. Welding of the electrode base material 13 and the tip 14 is performed by means of resistance welding in which current is applied between the first electrode 21 and the second electrode 22, after the electrode base material 13 and the tip 14 have been brought into contact with each other, the first electrode 21 has been brought into contact with the electrode base material 13, and the second electrode 22 has been brought into contact with the tip 14.

A first surface 31 of the electrode base material 13 makes contact with a third surface 33 of the tip 14. A contact surface 21a of the first electrode 21 is brought into contact with a second surface 32 of the electrode base material 13, and a contact surface 22a of the second electrode 22 is brought into contact with a fourth surface 34 of the tip 14.

In the present embodiment, current is applied between the first electrode 21 and the second electrode 22 while the tip 14 on which the electrode base material 13 is stacked is placed on the second electrode 22 and the first electrode 21 is pressed onto the second surface 32 of the electrode base material 13. The first surface 31 and the third surface 33 are melted and bonded to each other by Joule heat generated by contact resistance between the first surface 31 of the electrode base material 13 and the third surface 33 of the tip 14.

FIG. 3 is a perspective view of the tip 14 and the electrode base material 13. In FIG. 3, a portion of the electrode base material 13 in the longitudinal direction is not shown. FIG. 3 shows a state before resistance welding is performed.

As shown in FIG. 3, the electrode base material 13 has the second surface 32 and the first surface 31 that is different from the second surface 32. The second surface 32 is a surface having an area larger than or equal to an area 35 making contact with the contact surface 21a of the first electrode 21, and is produced by performing at least one of polishing and grinding on the electrode base material 13. The first surface 31 is a surface having an area larger than or equal to an area making contact with the third surface 33 of the tip 14, and is produced by performing at least one of polishing and grinding on the electrode base material 13. In the present embodiment, the first surface 31 is provided on a surface reverse to the second surface 32.

The tip 14 has the fourth surface 34 on the back of the third surface 33. The third surface 33 is a surface having an area smaller than or equal to an area making contact with the first surface 31 of the electrode base material 13, and the fourth surface 34 is a surface having an area smaller than or equal to an area making contact with the contact surface 22a of the second electrode 22. It is noted that the third surface 33 and the fourth surface 34 may be formed by punching out a plate material having a predetermined surface roughness in a predetermined size, or may be formed by performing at least one of polishing and grinding on the tip 14.

In the present embodiment, the second surface 32 of the electrode base material 13 is produced in such a size that the contact surface 21a of the first electrode 21 does not make contact with a surface 36 (the surface on which grinding or polishing is not performed) other than the second surface 32. As a result, only the second surface 32 can be easily brought into contact with the contact surface 21a of the first electrode 21. However, since the diameter of the contact surface 21a of the first electrode 21 is greater than the width of the electrode base material 13, when an electrode surface 21a makes contact with the electrode base material 13, the contact surface 21a protrudes in a width direction of the electrode base material 13.

The area of the first surface 31 of the electrode base material 13 is made larger than the area of the third surface 33 of the tip 14. Therefore, the entirety of the third surface 33 of the tip 14 can be easily brought into contact with the first surface 31.

The area of the contact surface 22a of the second electrode 22 is made larger than the area of the fourth surface 34 of the tip 14. Therefore, the entirety of the fourth surface 34 of the tip 14 can be easily brought into contact with the contact surface 22a of the second electrode 22.

The first surface 31 and the second surface 32 are each produced by a mechanical means using a grinding stone, a polishing material, a polishing cloth, abrasive paper, a polishing disc, a polishing belt, a polishing sleeve, a polishing wheel, a polishing brush, or the like. Grinding is an operation of chipping away at the surface and physically scraping the surface, and polishing is an operation of polishing the surface and decreasing surface roughness. Both polishing and grinding can be performed on the electrode base material 13, and only any one of grinding and polishing can also be performed on the electrode base material 13.

In a case where any one of polishing and grinding is performed on the electrode base material 13, polishing is suitably performed. This is because, since the amount to be chipped away from the surface by polishing can be further reduced as compared with that by grinding, surface roughness can be small while preventing decrease in accuracy of the dimensions of the electrode base material 13, and oxide film, oil film, and the like that attach to the surface can further be removed. It is noted that dry type grinding or dry type polishing that allows dispensing with an operation of drying or removing attachment after grinding or polishing is suitably used.

When the electrode base material 13 and the tip 14 are stacked with each other and current is applied between the first electrode 21 and the second electrode 22, Joule heat is generated by the contact resistance between the first surface 31 of the electrode base material 13 and the third surface 33 of the tip 14, and the first surface 31 and the third surface 33 are melted and bonded to each other. Since the first surface 31 and the second surface 32 are produced on the electrode base material 13, variations in contact resistance between the second surface 32 of the electrode base material 13 and the first electrode 21 and variations in contact resistance between the fourth surface 34 of the tip 14 and the second electrode 22 can be suppressed. As a result, variations in the contact resistance between the first surface 31 of the electrode base material 13 and the third surface 33 of the tip 14 can be suppressed. Since variations in the generated Joule heat can be suppressed, variations in welding of the electrode base material 13 and the tip 14 can be suppressed.

For the first surface 31 and the second surface 32 that are produced by performing at least one of grinding and polishing on the electrode base material 13, the arithmetic average roughness of the first surface 31 is set to be not less than the arithmetic average roughness of the second surface 32. That is, Joule heat generated in the tip 14 and the electrode base material 13 depends on the contact resistance between the first surface 31 of the electrode base material 13 and the third surface 33 of the tip 14. When the arithmetic average roughness of the first surface 31 is set to be not less than the arithmetic average roughness of the second surface 32, although depending on the surface roughness of each of the tip 14 and the first electrode 21, the contact resistance between the tip 14 and the electrode base material 13 can be greater than the contact resistance between the first electrode 21 and the electrode base material 13. Since the contact resistance between the first surface 31 of the electrode base material 13 and the tip 14 can be ensured, Joule heat generated between the tip 14 and the electrode base material 13 can be ensured. As a result, joining strength between the electrode base material 13 and the tip 14 can be ensured.

An arithmetic average roughness Ra is measured on the basis of JIS B0601 (1994 Edition). The arithmetic average roughness Ra is measured by means of VK-X110/X100 (manufactured by KEYENCE CORPORATION), which is a non-contact type shape measuring laser microscope.

The arithmetic average roughness of each of the first surface 31 and the second surface 32 of the electrode base material 13 is 2 to 4 μm. The arithmetic average roughness of each of the third surface 33 and the fourth surface 34 of the tip 14 is 0.4 to 0.8 μm. When the arithmetic average roughness of each of the third surface 33 and the fourth surface 34 of the tip 14 is 0.4 to 0.8 μm, in a case where the arithmetic average roughness of each of the first surface 31 and the second surface 32 of the electrode base material 13 is greater than 4 μm or less than 2 μm, the joining strength between the electrode base material 13 and the tip 14 tends to decrease. It is assumed that, when the arithmetic average roughness of each the first surface 31 and the second surface 32 is greater than 4 μm or less than 2 μm, the total area where the first surface 31 and the second surface 32 melt becomes small, whereby the cross-sectional area of a welding portion decreases and joining strength (particularly strength against shearing force due to thermal expansion of the electrode base material 13) decreases.

### EXAMPLES

The present invention will be more specifically described according to examples. However, the present invention is not limited to the examples.

### Example 1

30 rectangular plate-shaped electrode base materials each having a width of 2.7 mm and a thickness of 1.3 mm and 30 Cdisc-shaped tips each having a diameter of 1 mm and a thickness of 0.4 mm were prepared. Each electrode base material is formed from a nickel-based alloy, and each tip is formed from a platinum-nickel alloy. Dry type polishing was performed on a front surface and a rear surface of each electrode base material by means of a polishing belt, so that a rectangular-shaped first surface and a rectangular-shaped second surface each having a length of 6 mm and a width of 2.7 mm were produced on the front surface and the rear surface, respectively, of the electrode base material. Similarly, dry type polishing was performed on a front surface and a rear surface of each tip, so that a third surface and a fourth surface were produced on the front surface and the rear surface, respectively, of the tip.

Next, the arithmetic average roughness Ra of each of the first surface and the second surface of each of the 30 electrode base materials and the arithmetic average roughness Ra of each of the third surface and the fourth surface of each of the 30 tips were measured in a non-contact manner by means of VK-X110/X100 (manufactured by KEYENCE CORPORATION), which is the shape measuring laser microscope. The arithmetic average roughness of each of the first surface and the second surface of the electrode base material was obtained by measuring a rectangular range of 2.7 mm×1 mm of the first surface or the second surface. According to the measurement results, the arithmetic average roughness of each of the first surface and the second surface was in the range of 2.8 to 3.5 μm, and the arithmetic average roughness of each of the third surface and the fourth surface was in the range of 0.45 to 0.8 μm.

Immediately after the measurement, the tip was placed on the second electrode such that the fourth surface made contact with the second electrode of a resistance welding machine (power supply system was a single-phase AC system), the third surface of the tip and the first surface of the electrode base material were stacked with each other, and the first electrode was pressed onto the second surface of the electrode base material. Resistance welding was performed by pressing the first electrode and the second electrode to apply a load of 330 N in the thickness direction of the tip and the electrode base material, and by applying current between the first electrode and the second electrode (the number of current application cycles was 7, and the number of slopes that are a rise of the applied current was 2). The first electrode and the second electrode each were a cylindrical electrode having a diameter of 5 mm.

Since the electrode base material had a width of 2.7 mm and the second surface, produced on the electrode base material so as to make contact with the first electrode having a diameter of 5 mm, had a size of 6 mm×2.7 mm, in Example 1, the first electrode succeeded in not making contact with the surface other than the second surface. The output of power supply of the resistance welding machine was made constant, each of the 30 tips and each of the 30 electrode base materials were mutually welded, and a standard deviation of effective values (A) of current during 30 times of welding was measured.

### Comparative Example 1

A standard deviation of effective values (A) of current during 30 times of welding was measured as similar to Example 1, except that dry type polishing was performed on the front surface and the rear surface of each electrode base material by means of the polishing belt, so that a rectangular-shaped first surface and a rectangular-shaped second surface each having a length of 3 mm and a width of 2.7 mm were produced on the front surface and the rear surface, respectively, of the electrode base material. Comparative Example 1 is different from Example 1 in that the length of the second surface was shorter than the diameter of the first electrode.

Since the first electrode had a diameter of 5 mm and the second surface, produced on the electrode base material, had a size of 3 mm×2.7 mm, in Comparative Example 1, the first electrode made contact also with the unpolished surface other than the second surface. The entirety of the third surface of the tip made contact with the first surface produced on the electrode base material.

### Comparative Example 2

A standard deviation of effective values (A) of current during 30 times of welding was measured as similar to Example 1, except that dry type polishing was performed on each electrode base material by means of the polishing belt so that a rectangular-shaped second surface having a length of 3 mm and a width of 2.7 mm was produced on the electrode base material. Comparative Example 2 is different from Example 1 in that the length of the second surface was shorter than the diameter of the first electrode and that the first surface was not produced on the electrode base material.

Since the first electrode had a diameter of 5 mm and the second surface, produced on the electrode base material, had a size of 3 mm×2.7 mm, in Comparative Example 2, the first electrode made contact also with the unpolished surface other than the second surface. In addition, since the first surface was not produced on the electrode base material, the tip made contact with the unpolished surface of the electrode base material.

### Comparative Example 3

A standard deviation of effective values (A) of current during 30 times of welding was measured as similar to Example 1, except that polishing was not performed on each electrode base material. Comparative Example 3 is different from Example 1 in that the first surface and the second surface were not produced on the electrode base material. When, as similar to Example 1, the arithmetic average roughness was measured for the front surface and the rear surface of the electrode base material on which polishing was not performed, the arithmetic surface roughness was 2.5 to 3.0 μm. Since, in Comparative Example 3, the first surface and the second surface were not produced on the electrode base material, the tip and the first electrode made contact with the respective unpolished surfaces of the electrode base material.

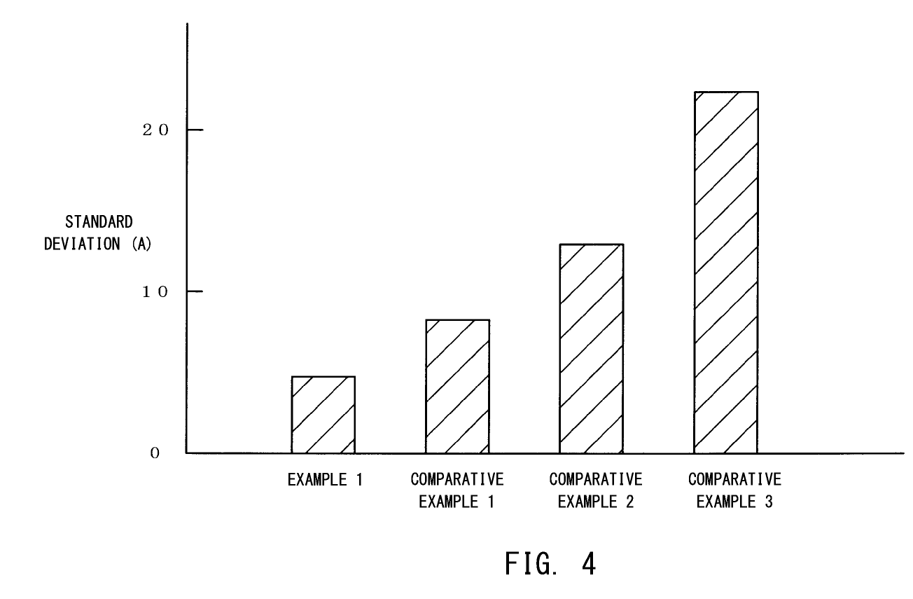

FIG. 4 shows the measurement results of a standard deviation of effective values (A). It was found that, as shown in FIG. 4, the standard deviation became smaller in descending order of Comparative Example 3, Comparative Example 2, and Comparative Example 1, and that Example 1 was able to have the smallest standard deviation of the four.

Comparative Example 1 is different from Example 1 in that the first electrode makes contact also with the unpolished surface other than the second surface. It is assumed that, when the first electrode makes contact with the unpolished surface other than the second surface, variations in contact resistance between the first electrode and the electrode base material become greater because of foreign matter, such as oil film or impurities, which attach to the unpolished surface. Accordingly, it is assumed that variations in effective values during welding became greater. In Example 1, variations in welding of the electrode base material and the tip can be suppressed, since the smaller the standard deviation of effective values during welding is, the less the individual difference among ground electrodes obtained by welding is.

### Example 2

As similar to Example 1, rectangular-shaped electrode base materials (each formed from a nickel-based alloy) each having a width of 2.7 mm and a thickness of 1.3 mm and disc-shaped tips (each formed from a platinum-nickel alloy) each having a diameter of 1 mm and a thickness of 0.4 mm were prepared. Dry type polishing was performed on the front surface and the rear surface of each electrode base material by means of the polishing disc, so that a rectangular-shaped first surface and a rectangular-shaped second surface each having a length of 6 mm and a width of 2.7 mm were produced on the front surface and the rear surface, respectively, of the electrode base material. Similarly, dry type polishing was performed on the front surface and the rear surface of each tip, so that a third surface and a fourth surface were produced on the front surface and the rear surface, respectively, of the tip.

The arithmetic average roughness Ra of each of the first surface and the second surface of each electrode base material was measured (the measurement range was a rectangular range of 2.7 mm×1 mm) by means of the laser microscope (VK-X110/X100), and the electrode base materials were classified into 10 sample classes (each sample class contains 10 samples) within the range of arithmetic average roughness of 0.75 μm to 5.75 μm (a sample class width of 0.5 μm). A total of 100 tips were prepared in which the arithmetic average roughness of each of the third surface and the fourth surface was 0.45 to 0.8 μm.

After the samples were classified, resistance welding was performed, by means of the resistance welding machine (power supply system was a single-phase AC system) used in Example 1, by applying current (target effective value of 1000 A) between the first electrode and the second electrode (the number of current application cycles was 7, and the number of slopes that are a rise of the applied current was 2) while applying a load of 330 N in the thickness direction of the tip and the electrode base material. After welding, a thermal cyclic test was performed in which 1000 cycles were performed on the samples with, as one cycle, a cycle in which the root of the tip was heated for two minutes by means of a burner, such that the temperature of the root became 1000° C., and was allowed to cool for one minute.

After the thermal cyclic test, a polished cross-sectional surface including the central axis of the tip was produced. The polished cross-sectional surface was observed by means of a metallograph, and a length L of oxide scale (a portion from which the tip was separated) present between the electrode base material and the tip was measured. A sample, in which a value obtained by dividing the length L (mm) by the diameter of the tip (1 mm) was not more than 0.5, was evaluated as acceptable, and a sample, in which the value exceeded 0.5, was evaluated as unacceptable.

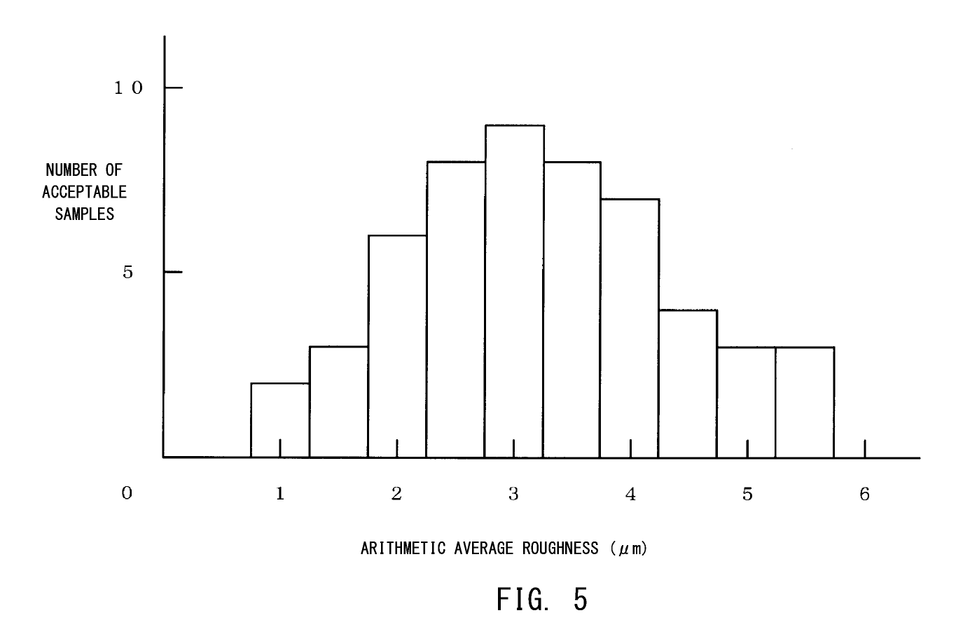

FIG. 5 is a histogram showing the number of acceptable samples in the thermal cyclic test. It was found that, as shown in FIG. 5, when a sample class value was 2 to 4 μm, the number of acceptable samples was not less than five. It is assumed that, when the sample class value is not less than 4.5 μm or the sample class value is not more than 1.5 μm, the total area where the tip and the electrode base material melt due to resistance welding became small, and strength against shearing force due to thermal expansion, of the electrode base material, which is generated in the thermal cyclic test decreases.

### Example 3

As similar to Example 1, rectangular plate-shaped electrode base materials (each formed from a nickel-based alloy) each having a width of 2.7 mm and a thickness of 1.3 mm and disc-shaped tips (each formed from a platinum-nickel alloy) each having a diameter of 1 mm and a thickness of 0.4 mm were prepared. Dry type polishing was performed on the front surface and the rear surface of each electrode base material by means of the polishing disc, so that a rectangular-shaped first surface and a rectangular-shaped second surface each having a length of 6 mm and a width of 2.7 mm were produced on the front surface and the rear surface, respectively, of the electrode base material. Similarly, dry type polishing was performed on the front surface and the rear surface of each tip, so that a third surface and a fourth surface were produced on the front surface and the rear surface, respectively, of the tip.

The arithmetic average roughness Ra of each of the first surface and the second surface of each electrode base material was measured (the measurement range was a rectangular range of 2.7 mm×1 mm) by means of the laser microscope (VK-X110/X100), and the electrode base materials were classified into Samples 1 to 3 each having the first surface (surface on the tip side) and the second surface (surface on the first electrode side) both of which have various arithmetic average roughness. The sample class width was 0.5 μm, and each Sample contained 10 samples. A total of 30 tips were prepared in which the arithmetic average roughness of each of the third surface and the fourth surface was 0.45 to 0.8 μm.

After the samples were classified, resistance welding was performed, by means of the resistance welding machine (power supply system was a single-phase AC system) used in Example 1, by applying current (target effective value of 1000 A) between the first electrode and the second electrode (the number of current application cycles was 7, and the number of slopes that are a rise of the applied current was 2) while applying a load of 330 N in the thickness direction of the tip and the electrode base material. After welding, the thermal cyclic test was performed as similar to that of Example 2, and, after the test, the polished cross-sectional surface including the central axis of the tip was produced.

The polished cross-sectional surface was observed by means of the metallograph, and the length L of oxide scale (a portion from which the tip was separated) present between the electrode base material and the tip was measured. The Sample, in which not less than five of the 10 samples had a value that exceeded 0.3, the value being obtained by dividing the length L(mm) by the diameter of the tip (1 mm), was evaluated as unacceptable. The Sample, in which less than five of the 10 samples had a value that was not more than 0.3, was evaluated as acceptable.

TABLE 1

Sample class value (μm)

| | First surface | Second surface | Results |
|---|---|---|---|
| Sample 1 | 2 | 4 | Unacceptable |
| Sample 2 | 3 | 3 | Acceptable |
| Sample 3 | 4 | 2 | Acceptable |

Table 1 is a list of the test results. As indicated in Table 1, Samples 2 and 3, in which the arithmetic average roughness of the first surface (surface on the tip side) was not less than the arithmetic average roughness of the second surface (surface on the first electrode side), were evaluated as acceptable, and Sample 1, in which the arithmetic average roughness of the first surface was less than the arithmetic average roughness of the second surface, was evaluated as unacceptable. It is assumed that, since Samples 2 and 3 each had the arithmetic average roughness of the first surface that was not less than the arithmetic average roughness of the second surface, Samples 2 and 3 each ensured contact resistance between the first surface of the electrode base material and the tip. As a result, it is assumed that Joule heat during resistance welding was ensured and joining strength between the electrode base material and the tip was ensured, so that Samples 2 and 3 were evaluated as acceptable in the thermal cyclic test.

### Example 4

Samples of the spark plug were manufactured as follows. Firstly, after the center electrode was inserted into the axial hole of the insulator, electrical connection was ensured between the metal terminal inserted into the axial hole and the center electrode. Next, the metal shell to which the electrode base material of the ground electrode was joined in advance was assembled to the outer circumference of the insulator. Next, after dry type polishing was performed on the electrode base material by means of a polishing brush, the tip on which dry type polishing was performed was joined to the electrode base material by means of resistance welding, so that 10 samples of the spark plug were obtained.

As similar to Example 1, rectangular-shaped electrode base materials (each formed from a nickel-based alloy) each having a width of 2.7 mm and a thickness of 1.3 mm, and disc-shaped tips (each formed from a platinum-nickel alloy) each having a diameter of 1 mm and a thickness of 0.4 mm were used. By means of dry type polishing, a rectangular-shaped first surface and a rectangular-shaped second surface each having a length of 6 mm and a width of 2.7 mm were produced on the front surface and the rear surface, respectively, of each electrode base material. Similarly, by means of dry type polishing, a third surface and a fourth surface were produced on the front surface and the rear surface, respectively, of each tip.

The arithmetic average roughness of each of the first surface and the second surface measured (the measurement range was a rectangular range of 2.7 mm×1 mm) by means of the laser microscope (VK-X110/X100) was 3 μm. The arithmetic average roughness of each of the third surface and the fourth surface, measured similarly, was 0.45 to 0.8 μm. When, after resistance welding, a notch was formed in the fourth surface (surface on the side opposite to the tip) of the electrode base material and the electrode base material was bent by 90 degrees, separation occurred between the tip and the electrode base material in two of the 10 samples.

### Example 5

10 samples in Example 5 were manufactured as similar to Example 4, except that after the electrode base material of the ground electrode was joined to the metal shell, dry type polishing was performed on the electrode base material by means of the polishing brush, the metal shell was then assembled to the insulator, and resistance welding was performed on the tip and the electrode base material after the assembly. As similar to Example 4, when a notch was formed in the fourth surface (surface on the side opposite to the tip) of the electrode base material and the electrode base material was bent by 90 degrees, separation occurred between the tip and the electrode base material in four of the 10 samples.

When Example 4 and Example 5 are compared with each other, since the number of samples in which separation occurred was less in Example 4 than in Example 5, adhesion between the tip and the electrode base material was more stable in Example 4 than in Example 5. It is assumed that, since, in Example 5, polishing was performed on the electrode base material of the ground electrode before the metal shell was assembled to the insulator, foreign matter such as oxide film attached to the front surface of the electrode base material in the time period from the end of polishing to the start of resistance welding. Meanwhile, it is assumed that, since, in Example 4, polishing was performed on the electrode base material of the ground electrode after the metal shell was assembled to the insulator, foreign matter such as oxide film is hardly generated on the front surface of the electrode base material in the time period from the end of polishing to the start of resistance welding. Accordingly, it is assumed that, in Example 4, variations in adhesion strength of the tip was suppressed.

As described above, although the present invention has been described based on the embodiments, the present invention is not limited to the above embodiments at all. It can be easily understood that various modifications can be devised without departing from the gist of the present invention. For example, the shapes and the dimensions of the electrode base material 13 and the tip 14 are mere examples and may be set as appropriate.

Although, in the above embodiments, the case has been described where the resistance welding machine in which the power supply system is a single-phase AC system is used, the resistance welding machine is not limited thereto. As a matter of course, a power supply system, such as a single-phase DC system, an inverter system, a capacitor system, and the like, may be set as appropriate.

Although, in the above embodiments, the case has been described where the second surface 32 is produced on the back of the first surface 31 of the electrode base material 13 and the first electrode 21 and the second electrode 22 are disposed on the straight line, the present invention is not limited thereto. As a matter of course, a pressing member (not shown) that presses, together with the second electrode 22, the electrode base material 13 and the tip 14 may be disposed on the straight line on which the second electrode 22 is located, and the first electrode 21 for current application, independently of the pressing member, may be provided to make contact with the electrode base material 13. In this case, the second surface may be produced at any position where the first electrode 21 makes contact with the electrode base material 13.

### DESCRIPTION OF REFERENCE NUMERALS

10: spark plug
12: ground electrode
13: electrode base material
14: tip
21: first electrode
22: second electrode
31: first surface
32: second surface
33: third surface
34: fourth surface

1. A method for manufacturing a spark plug by joining a tip containing a noble metal to an electrode base material by means of resistance welding in which current is applied between a first electrode and a second electrode, to obtain a ground electrode, the method comprising:
an electrode base material adjusting step including a first step of producing, on the electrode base material, a first surface having an area larger than or equal to an area making contact with the tip by performing at least one of polishing and grinding on the electrode base material, and a second step of producing, on the electrode base material, a second surface having an area larger than or equal to an area making contact with the first electrode by performing at least one of polishing and grinding on the electrode base material; and
a welding step of performing resistance welding by applying current between the first electrode and the second electrode, after bringing the first surface of the electrode base material and the tip into contact with each other, bringing the first electrode into contact with the second surface of the electrode base material, and bringing the second electrode into contact with the tip, wherein
in the electrode base material adjusting step, an arithmetic average roughness of the first surface is set to be not less than an arithmetic average roughness of the second surface.

2. A method for manufacturing the spark plug according to claim 1, wherein
in the case where a surface, of the tip, making contact with the electrode base material is defined as a third surface and a surface, of the tip, making contact with the second electrode is defined as a fourth surface,
the arithmetic average roughness of each of the first surface and the second surface of the electrode base material is 2 to 4 μm, and an arithmetic average roughness of each of the third surface and the fourth surface of the tip is 0.4 to 0.8 μm.

3. A method for manufacturing the spark plug according to claim 1, further comprising
an assembling step of assembling a tubular metal shell to which the ground electrode is joined to an outer circumference of a tubular insulator, wherein
after the assembling step, the electrode base material adjusting step is performed.

4. A method for manufacturing the spark plug according to claim 2, further comprising:
a third step of producing the third surface on the tip by performing at least one of polishing and grinding thereon; and
a fourth step of producing the fourth surface on the tip by performing at least one of polishing and grinding thereon.
